(19) United States
(12) Patent Application Publication
(10) Pub. No.: US 2004/0108702 A1
(43) Pub. Date: Jun. 10, 2004

(54) Folding ergonomic wheel apparatus

(76) Inventor: David L. McGrew, Villanova, PA (US)

Correspondence Address: LITMAN LAW OFFICES, LTD., P.O. BOX 15035 CRYSTAL CITY STATION, ARLINGTON, VA, 22215, US

(21) Appl. No.: 10/309,215

(22) Filed: Dec. 4, 2002

(51) Int. Cl. B60S 9/02

(52) U.S. Cl. 280/763.1

(57) ABSTRACT

A manual cranking apparatus for THE landing gear of a semi-trailer. THE cranking apparatus includes a spoked wheel which is permanently connected via an articulating shaft to THE operating cross-shaft of THE landing gear. THE articulated shaft is arranged to allow THE apparatus to be folded such that, in storage position, THE wheel is positioned beneath THE trailer. In use, THE apparatus is unfolded so that THE diametric plane of THE wheel is parallel to THE side of THE trailer. When unfolded, THE wheel is positioned at a height which enables THE operator to assume an erect posture, thereby reducing THE potential for back strain and increasing the amount of torque generated by THE same amount of muscular force.

### BACKGROUND OF THE INVENTION

1. Field of THE Invention

THE present invention generally relates to support devices. More specifically, THE present invention is drawn to a mechanical device for raising and lowering THE landing gear on a semi-trailer.

2. Description of THE Related Art

Usually, a semi-trailer is loaded and unloaded in a free-standing position (unattached to THE cab). Landing gear must be lowered to support THE semi-trailer in this free-standing position. THE landing gear must be raised when THE trailer is reattached to THE cab. In most instances THE landing gear is raised and lowered by manipulating a hand crank. Hand cranking requires that the operator bend over to rotate THE crank. This scenario increases THE potential for back strain and requires an inordinate amount of repetitive muscular exertion. Manually turning THE landing gear crank is THE second highest cause of injury, lost work time and worker's compensation expense for truck drivers. Ergonomics is the science of fitting THE physical demands of THE job to THE worker to reduce or eliminate repetitive motion injuries that can lead to such disorders as tendinitis, repetitive stress syndrome and back problems. There are more than one million such injuries annually according to THE National Academy Of Science. A manual cranking apparatus, which apparatus would reduce THE potential for muscular-skeletal injury and provide for more efficient torquing would certainly be a welcome addition to THE art.

There is a plethora of devices in THE prior art for raising and lowering landing gear sans hand cranks. For example, U.S. Pat. No. 4,466,637 (Nelson), U.S. Pat. No. 6,224,103 B1 (Hatcher) and U.S. Pat. No. 6,260,882 (Kingsbury) employ electric motors to raise and lower the landing gear.

U.S. Pat. No. 4,402,526 (Huetsch), U.S. Pat. No. 5,451,076 (Burkhead) and U.S. Pat. No. 5,911,437 (Lawrence) utilize pneumatic actuators, while U.S. Pat. No. 4,928,488 (Hunger) provides a hydraulic actuator to raise and lower THE landing gear.

All of THE systems disclosed in THE above cited references require a substantial amount of refitting to existing trailers, which refitting would entail a large expense. Furthermore, all the systems are relatively complicated and would require relatively extensive and costly maintenance.

None of THE above inventions and patents, taken either singularly or in combination, is seen to disclose a folding, ergomnomic wheel apparatus for raising and lowering landing gear as will subsequently be described and claimed in THE instant invention.

### SUMMARY OF THE INVENTION

THE present invention is a manual cranking apparatus for raising and lowering THE landing gear of a semi-trailer. The cranking apparatus includes a spoked wheel which is permanently connected via an articulating shaft to THE operating cross-shaft of THE landing gear. THE articulating shaft is arranged to allow the apparatus to be folded such that, in storage position, THE wheel is positioned beneath THE trailer. In use, THE apparatus is unfolded so that THE diametric plane of THE wheel is parallel to THE side of THE trailer. When unfolded, THE wheel is positioned at a height which enables THE operator to assume an erect posture, thereby reducing THE potential for back strain. THE use of a wheel to rotate THE cross-shaft permits a more efficient application of torque.

Accordingly, it is a principal object of THE invention to provide an improved manual cranking apparatus for THE landing gear of a semi-trailer.

It is another object of THE invention to provide an improved manual cranking apparatus, which apparatus allows a user to assume an erect posture when operating THE apparatus.

It is a further object of THE invention to provide a manual cranking apparatus, which apparatus can be folded and stored beneath THE semi-trailer.

Still another object of THE invention is to provide a manual cranking apparatus, which apparatus employs a spoked wheel to enhance tourqing efficiency.

It is an object of THE invention to provide improved elements and arrangements thereof for THE purposes described which are inexpensive, dependable and fully effective in accomplishing their intended purposes and is generally compatible with all existing semi-trailer landing gear models.

These and other objects of THE present invention will become readily apparent upon further review of THE following specification and drawings.

### BRIEF DESCRIPTION OF THE DRAWINGS

FIG. 1 is an environmental, perspective view of a folding ergonomic wheel apparatus in storage position according to the present invention.

FIG. 2 is a an environmental, perspective view of a folding ergonomic wheel apparatus in an extended in-use position according to THE present invention.

FIG. 3 is a top view of THE wheel apparatus in an extended position according to THE present invention.

FIG. 4 is a perspective view of THE wheel apparatus in folded storage position according to THE present invention.

Similar reference characters denote corresponding features consistently throughout THE attached drawings.

### DETAILED DESCRIPTION OF THE PREFERRED EMBODIMENTS

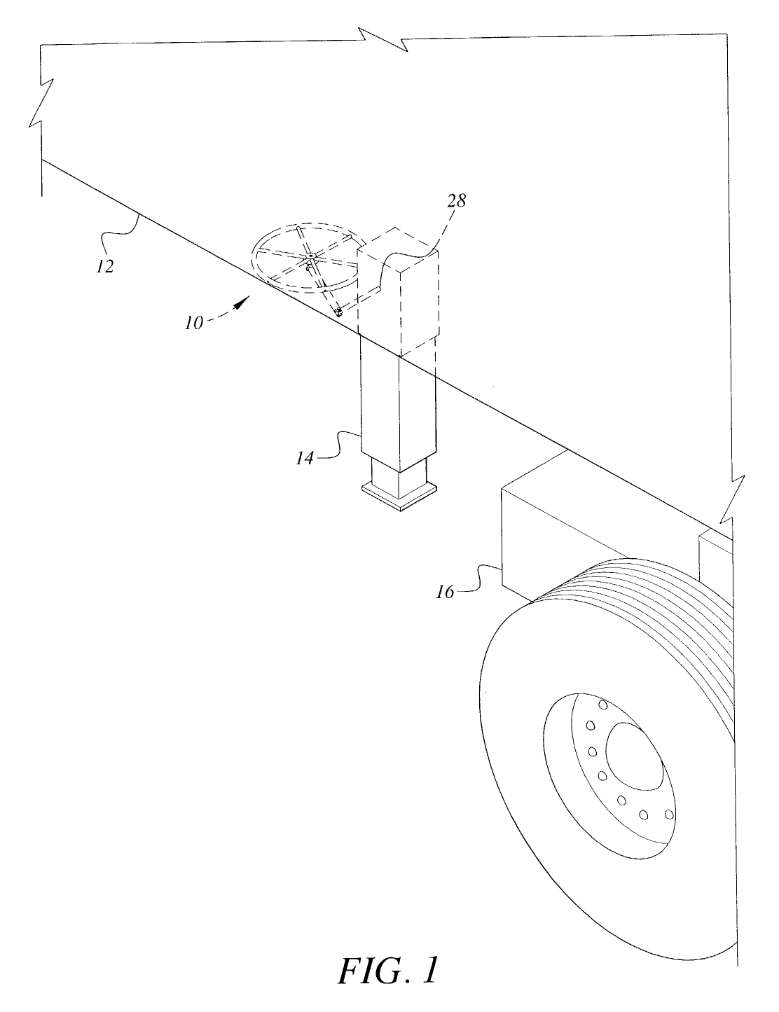

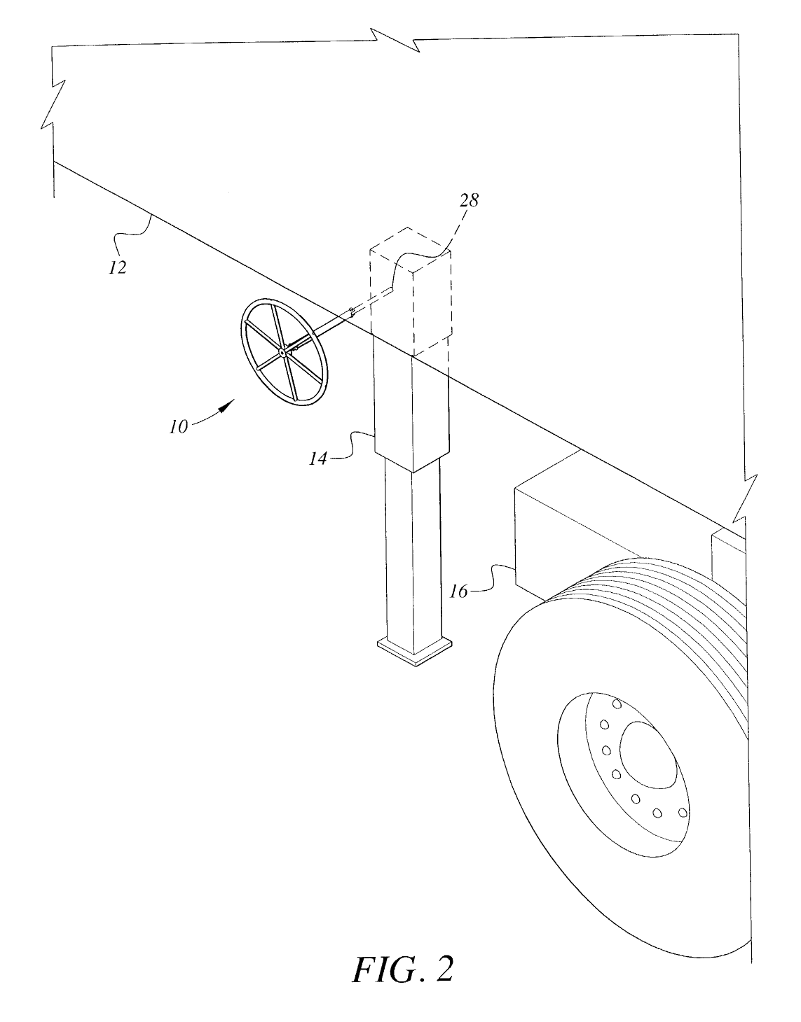

Attention is first directed to FIGS. 1 and 2 of THE drawings wherein THE folding, ergonomic, raising and lowering apparatus of THE present invention is generally indicated at 10. As shown in FIG. 1, apparatus 10 is depicted in a collapsed or folded position and is stored beneath THE body of semi-trailer 12 adjacent to landing gear 14. In FIG. 2, THE apparatus 10 is depicted in an extended in-use position before THE cab 16 is driven away.

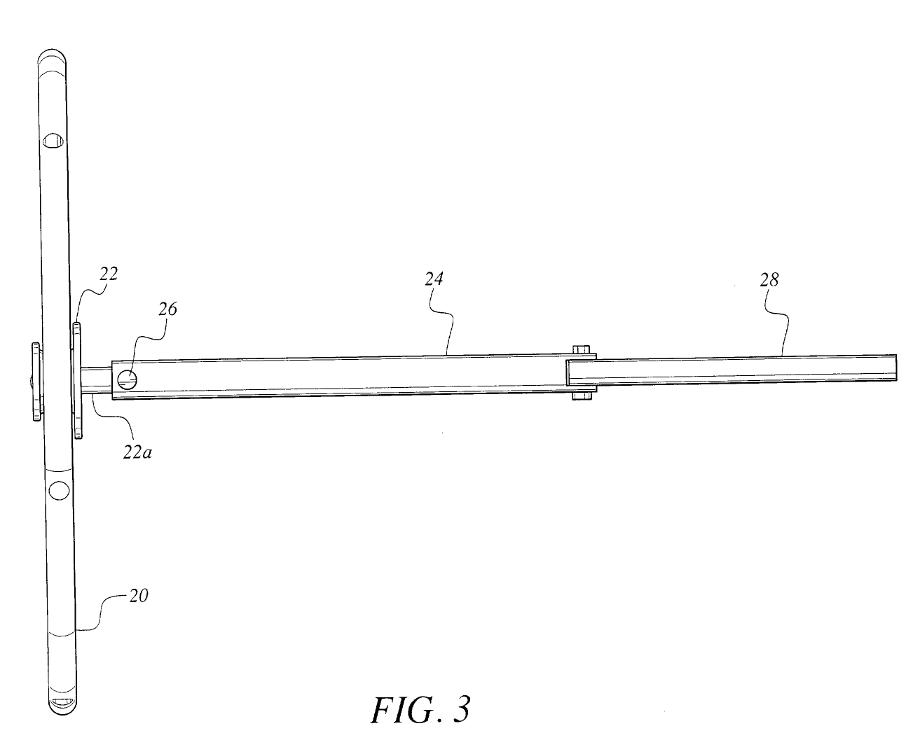

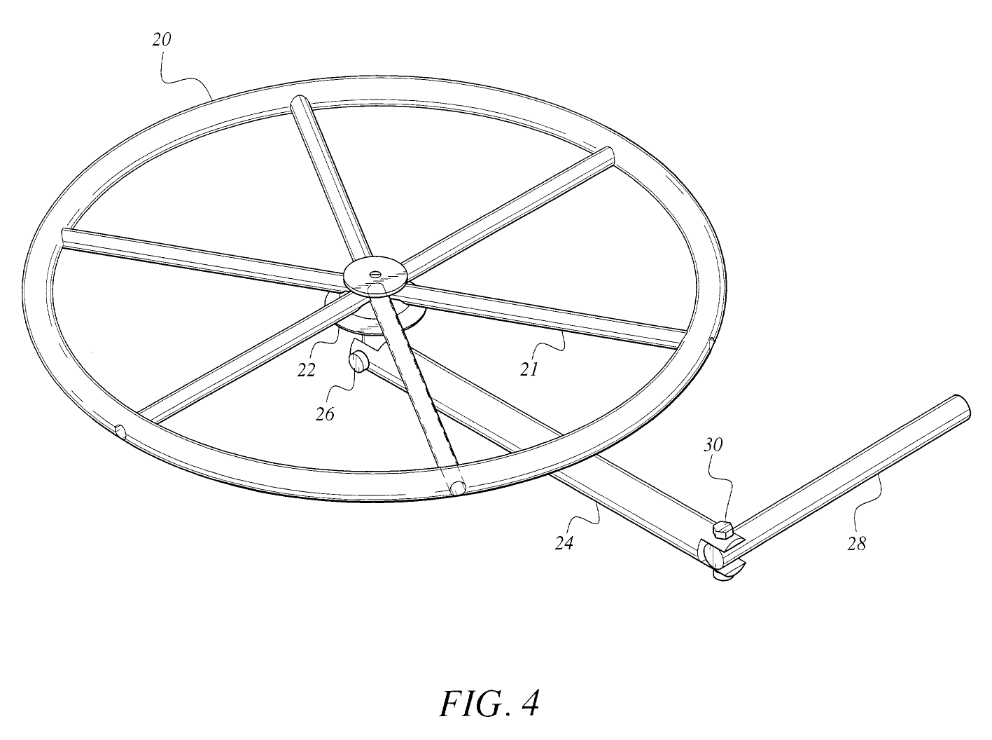

As best seen in FIGS. 3 and 4, apparatus 10 comprises a spoked wheel 20 having a central hub 22 and stub 22a. THE spokes 21 of THE wheel are hollow and open at THE rim of THE wheel for purposes as will be explained below. A shaft 24 is articulately attached at a proximate end to stub 22a. A hinge 26 having a ninety degree range of movement about its axis is employed to effect the attachment. THE distal end of shaft 24 is attached to THE cross-shaft 28 of THE landing gear via a hinge 30, which hinge enables a one-hundred-eighty degree range of movement about its axis. The axis of hinge 26 is perpendicular to THE axis of hinge 30. Landing gear 14 and cross-shaft 28 are conventional and are not, per se, a part of THE inventive concept. In use, rotation of wheel 20 in one direction will raise THE landing gear. When THE wheel is rotated in THE opposite direction THE landing gear will be lowered. Although metal is preferred, wheel 20 and shaft 24 may be fabricated from any suitable, durable material. If necessary, a rod(s) may be inserted into THE hollow spokes to extend the effective diameter of THE wheel and thereby enhance THE torquing leaverage. It is contemplated that THE spokes of THE wheel may be telescopic (not shown) so that THE diameter of THE wheel may varied. THE wheel may also take a multi-sided shape to better enable THE usability of THE hollow spokes. These arrangements would allow for customized applications to increase or decrease the torque needed to turn THE wheel during THE raising or lowering process. THE hinges may be provided with conventional, easy-release locking structure whereby to lock THE hinges in THE in-use position.

As described above, THE hinge arrangement permits THE wheel to be folded for storage (FIG. 1) when not in use and extended to an in-use position (FIG. 2) whereby a user can raise and lower the landing gear without bending or stooping.

It is to be understood that THE present invention is not limited to THE embodiment described above, but encompasses any and all embodiments within THE scope of THE following claims.

I claim:

1. In combination with a semi-trailer having an exterior side, an undersurface and landing gear, wherein said landing gear has a cross-shaft, an apparatus for raising and lowering said landing gear, said apparatus comprising:
a rotatable member, said rotatable member attached to said cross-shaft for rotating said cross-shaft in a first direction to raise said landing gear and for rotating said cross-shaft in a second direction to lower said landing gear; and
means connecting said rotatable member to said cross-shaft, whereby said rotatable member can be collapsed to assume a storage position beneath said undersurface and extended to an in use position adjacent said exterior side.

2. THE combination as recited in claim 1, wherein said means is an articulating shaft.

3. THE combination as recited in claim 1, wherein said rotatable member is a spoked wheel.

4. THE combination as recited in claim 3, wherein THE spokes of said wheel are hollow.

5. THE combination as recited in claim 1, wherein said rotatable member has a diametrical plane and wherein said diametrical plane is parallel to said exterior side when said rotatable member is in said extended in-use position.

6. THE combination as recited in claim 1, wherein said means is an articulating shaft, said shaft having a proximate end attached to said rotatable member.

7. THE combination as recited in claim 6, wherein said shaft has a distal end and wherein said distal end is attached to said cross-shaft.

8. THE combination as recited in claim 7, including a ninety degree hinge disposed on said proximate end, said ninety degree hinge having an axis of rotation, wherein said ninety degree hinge attaches said proximate end to said rotatable member.

9. THE combination as recited in claim 8, including a one-hundred-eighty degree hinge disposed on said distal end, said one-hundred-eighty degree hinge having an axis of rotation, wherein said one-hundred-eighty degree hinge attaches said distal end to said cross-shaft.

10. THE combination as recited in claim 9, wherein said axis of rotation of said ninety degree hinge is perpendicular to said axis of rotation of said one-hundred-eighty degree hinge.

11. An apparatus for raising and lowering landing gear of a semi-trailer comprising:
a cross-shaft disposed on said landing gear;
a spoked wheel; and
means connecting said spoked wheel to said cross-shaft for rotating said cross-shaft in a first direction to raise said landing gear and for rotating said cross-shaft in a second direction to lower said landing gear.

12. An apparatus as recited in claim 11, wherein said means is an articulating shaft having a proximate end and a distal end.

13. An apparatus as recited in claim 12, wherein said proximate end of said shaft is attached to said spoked wheel and wherein said distal end of said shaft is attached to said cross-shaft.

14. An apparatus as recited in claim 13, including a ninety degree hinge disposed on said proximate end, said ninety degree hinge having an axis of rotation, wherein said ninety degree hinge attaches said proximate end to said rotatable member.

15. An apparatus as recited in claim 14, including a one-hundred-eighty degree hinge disposed on said distal end, said one-hundred-eighty degree hinge having an axis of rotation, wherein said one-hundred-eighty degree hinge attaches said distal end to said cross-shaft.

16. An apparatus as recited in claim 15, wherein said axis of rotation of said ninety degree hinge is perpendicular to said axis of rotation of said one-hundred-eighty degree hinge.
